(19) United States
(12) Patent Application Publication
(10) Pub. No.: US 2009/0240567 A1
(43) Pub. Date: Sep. 24, 2009

(54) INTERACTIVE MARKETING SYSTEM

(75) Inventors: Devon Kinkead, Holliston, MA (US); Merritt W. Mayher, Boston, MA (US); Charla Jones, Roslindale, MA (US); Venkat Rangamani, Shrewsbury, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Micronotes, LLC, Cambridge, MA (US)

(21) Appl. No.: 12/390,972

(22) Filed: Feb. 23, 2009

Related U.S. Application Data
(60) Provisional application No. 61/066,573, filed on Feb. 21, 2008.

(51) Int. Cl. G06Q 10/00; G06Q 30/00; G06Q 40/00; G06F 17/30; G10L 13/08

(52) U.S. Cl. 705/10; 705/1; 705/26; 705/7; 705/39; 705/14; 707/3; 705/35; 704/260; 707/104.1; 707/E17.044; 707/E17.108; 704/E13.001

(57) ABSTRACT

The present invention is a system which enables a marketing team to initiate and sustain directed and interactive communication with thousands or millions of existing or prospective customers. In the preferred embodiment, a marketer accesses a database and selects a group of qualified prospects, using lifestyle dimensions and or demographic information, from a stable group of prospective or existing customers conducting financial transactions online. Once a prospect list is selected, the marketer designs a series of questions, typically using branch and skip logic, and the system deploys the question sequence to the target list in the form of a response-redeemable savings coupon. When prospects are next performing their financial transactions online, they are presented with a lifestyle-relevant coupon which is immediately redeemable by responding to the question/communication, therewith lowering the respondent's bill instantaneously upon response, as in the case of online bill payment. Reponses are made available to the marketer who can use this information to further segment and qualify respondents. The marketer can then initiate a new, more relevant line of inquiry, based on previous responses, with a more highly qualified subset of prospects. By repeating an ever more relevant communication process with an increasingly qualified prospect group, which ultimately may result in a welcomed invitation to purchase a product or service (e.g. in the form of a coupon redeemable with product or service purchase), both marketer and consumer engage in an interactive relationship. The present invention can use systems and methods for the payment of debts. A communications network can be used by debtors to acquire and transfer funds, securities or any other transferable instrument that increases in value with time to satisfy the debt.

### CROSS REFERENCE TO RELATED APPLICATIONS

The present application claims priority to U.S. Provisional Patent Application No. 61/066,573 filed Feb. 21, 2008. The entire contents of the above application is incorporated herein by reference.

### BACKGROUND OF THE INVENTION

Systems for electronic marketing of goods and services via public access networks have utilized paid search advertising using a vendors' website. However, these methods do not provide for an interactive marketing capability, usually because the user is not motivated to participate in surveys and is unlikely to return to a website on a periodic basis.

Techniques commonly referred to as business intelligence (BI) relate to tools used to report and analyze information relating to financial marketing sales. These tools utilize multidimensional database search and analyzes methods. One system that involves periodic networked communications are electronic bill paying systems. In the development of the banking system and financial markets an important principle is the time value of money. That is, people are willing to wait for their money only if they have an interest in doing so. Hence, the creation of interest payments. These principles create friction at the interface between debtor and the creditor insofar as the debtor is paid interest for holding on to their money as long as possible while the creditor is left to devise penalties for late payment to counteract the debtor's interests in delaying payment. For example, people will, for a variety of reasons, mail a credit card bill late only to find a late fee on their next bill which exceeds the time value of that money by several hundred times. Some charges go through, others are contested but, either way, debtors, and in same circumstances creditors lose money and time, and the credit scores of debtors are impacted in the process. Most detest paying bills and that sentiment combined with people's penchant for holding on to their money until the last possible moment combines to yield significant losses for consumers and small businesses, and for the creditors themselves.

Ideally, if parties pay their bills on-time, there wouldn't be any need for late fees or time spent disputing such fees. Moreover, market research data suggests that there isn't much difference in late charge experience, if any, between those who report paying their bills early versus those who report that they pay bills only when they have the money to pay those same bills. Why do those who have the money to pay their bills report any problems around late fees? The explanation is that people find the process of paying bills tedious and distasteful and couple that with people's interest in holding onto money as long as possible, the result is procrastination, which leads to late charges, disputes, and compromised credit scores. The incentives of the users in this system are such that late charges, disputes, and compromised credit scores are a perpetual reality within the system.

There is consequently a need for further improvement in systems and methods for conducting marketing operations in combination with financial transactions.

### SUMMARY OF THE INVENTION

Preferred embodiments of the present invention relate to marketing of goods and/or services using a public access network, and more particularly to interactive direct marketing with periodic users of network sites. Periodic users of a website system engage in financial transactions occurring on a regular basis typically in connection with the monthly payment of debts. Alternatively, periodic use of a network site can involve subscription services of various kinds in which a user participates in periodic communication enabling periodic interactive marketing.

The purpose of all marketing and sales activities is to locate a qualified prospect and sell that prospect a product or service. Effective sales conversations with consumers have historically been confined to the shop floor where a sales person and prospect interact in a directed conversation insofar as, a good sales person's next question depends upon the prospect's answer to the previous question. For example, if a shoe salesperson asks, “May I help you find some shoes?”—if the prospect's answer is, “No, thanks—I am just waiting for my mother” —the next question ought not be, “we'll, what kind of shoes are you looking for?”—that question would be a waste of sales effort and an annoyance to the prospect.

In effect, however, much of advertising works like our bad salesperson example. “Would you like to buy a cell phone?” “No, thanks . . . I just bought one yesterday (silently)” “Which model would you like to buy?” Advertising response rates ranging between 0.001% and 2.5% are ample evidence of this lack of relevance and feedback, setting aside, for the moment, another objective of advertising being to build brand awareness.

The best solution to date to this problem has been paid search advertising wherein a self-selected group of interested parties find relevant merchants based on the search system's review of the merchant's website content and the price paid by the merchant to the search company for the search term.

To facilitate more effective access to consumer of goods and services, preferred embodiments of the present invention utilize systems involving periodic networked communications and an interactive communication sequence, along with an incentivized participation process to provide a more reliable networked marketing system.

The system provides access to marketers of companies to engage in a series of communications with users based on access to one or more databases providing three or more dimensional of searchable data. Companies can then be organized to query periodic users of a system regarding their use of goods and services and compensating the users for each response.

A preferred embodiment utilizes the periodic nature of many financial transactions that occur using public access networks along with an interactive communication process that a user is motivated to use due to incentive of obtaining further discounts for existing debits and/or in connection with future purchases of goods and services. A preferred embodiment of the invention provides systems and methods that incentivize debtors to pay early, as well as participate in one or more marketing campaigns, thereby leading to lowered debt costs and improved credit scores. This system provides a method of acquiring and aggregating debt payments at a discount, and then investing those debt payments into financial instruments which increase in value with time before the due date, while at the same time assuming and paying that same debt obligation. This system incentivizes early payment by the debtor, which lowers debt payment costs and improves debtor credit scores. The same system also rewards creditors with more timely cash inflows and lower customer conflict and service costs.

A preferred embodiment of the invention utilizes one or more communication networks to execute various functions of the debt payment and marketing system. A user can access the system using a personal computer such as a desktop, laptop or handheld computer, or by standard telephone (POTS) service, wireless cellular telephone, or Web enabled telephone device. A public access communication network such as the Internet can be used with a computer program operating on the computer, telephone or other device to enter information, obtain information via the communications network and execute the transfer of funds necessary to acquire financial instruments and/or pay debts in accordance with the invention.

A preferred embodiment of the invention utilizes an automated system to obtain money market and bond rates via a public access network, or through a dedicated server that periodically updates rate information.

Different vendors such as banks or other financial vendors can provide a system in which the user can provide for payment in advance of a due date at a lower amount. For example, a bank or other vendor, can have a server system that is accessed by a debtor to effectuate payment of debts to the bank and/or other parties. The debt obligation can also comprise a debt to be incurred in the future such as the purchase of products or gifts at a future date, the payment of no interest or low interest loans, or the payment of a tax obligation.

### BRIEF DESCRIPTION OF THE DRAWINGS

FIG. 1A schematically illustrates a system for direct marketing in accordance with a preferred embodiment of the invention.

FIG. 1B illustrates a system to access and perform online analytical processing.

FIG. 2A illustrates a screenshot and associated demographics entry form used to initiate participants in a debt payment and marketing system.

FIG. 2B is an example of a graphical user interface in accordance with a preferred embodiment of the invention.

FIG. 2C is a schematic of communication networks in accordance with a preferred embodiment of the invention.

FIG. 3 is a process sequence for paying debts in accordance with a preferred embodiment of the invention.

FIG. 4 illustrates the use of a wireless cellular telephone with a screenshot used to prepay in accordance with the invention.

FIG. 5 is a screenshot of a program used by a financial institution or other vendor.

FIG. 6 illustrates a screenshot in which a bank or other vendor utilizes a discounted electronic bill paying process.

FIG. 7 illustrates an example of a partial payment system.

FIG. 8 illustrates a sequence of queries and respondent options.

FIG. 9 illustrates a marketer entry form that enables access to marketer participation.

FIG. 10 illustrates data accessed from system memory by marketers.

FIG. 11 illustrates a screenshot form for marketer selection of appointments with users based on data analysis.

FIG. 12 illustrates a screenshot of a conversation design routine that marketers access to implement a particular conversation.

FIG. 13 illustrates a preferred embodiment of a coupon used to reduce a user's particular debt in response to queries.

FIG. 14 illustrates data collection recording in memory and display.

FIG. 15 illustrates the three query response tree that generates eight possible responses which can be used to measure system performance.

FIG. 16 illustrates data storage and analysis to evaluate and modify marketing program.

FIG. 17 illustrates the use server that communicates with a server used for financial transactions, such as a bank server conducting bill paying operations from bank accounts of bank customers.

FIG. 18A illustrates an example of the Bayesian Truth Serum method.

FIG. 18B illustrates the use of regression coefficients as utilities.

FIG. 19A illustrates the assignment of utilities to each user.

FIG. 19B illustrates a communication tree involved in the purchase of a product such as an automobile.

FIG. 20 illustrates a rotating savings and credit organization (ROSCA) system in accordance with a preferred embodiment of the invention.

### DETAILED DESCRIPTION OF THE INVENTION

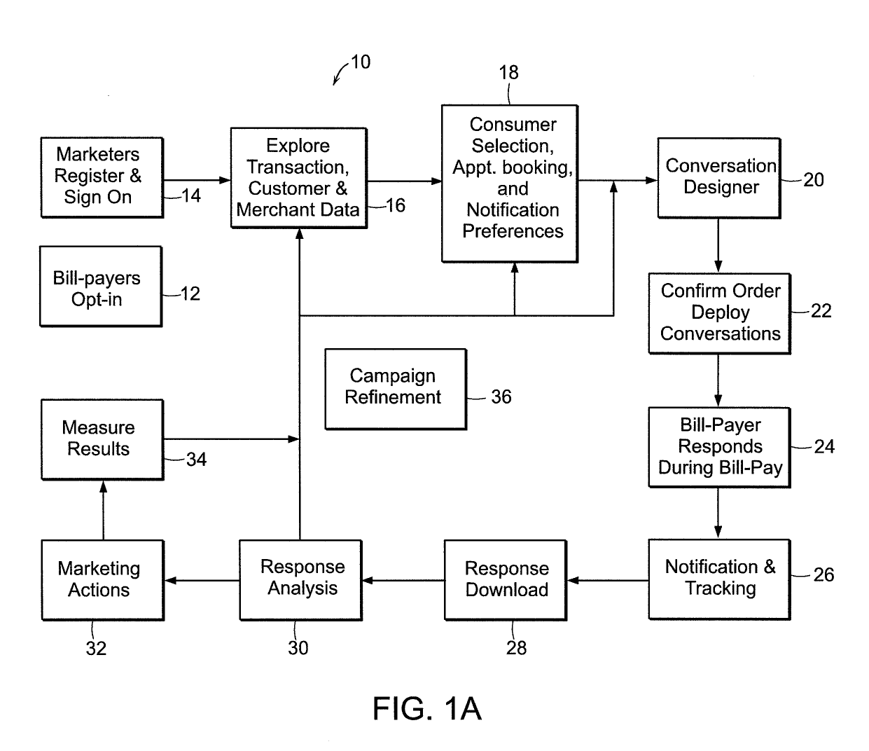

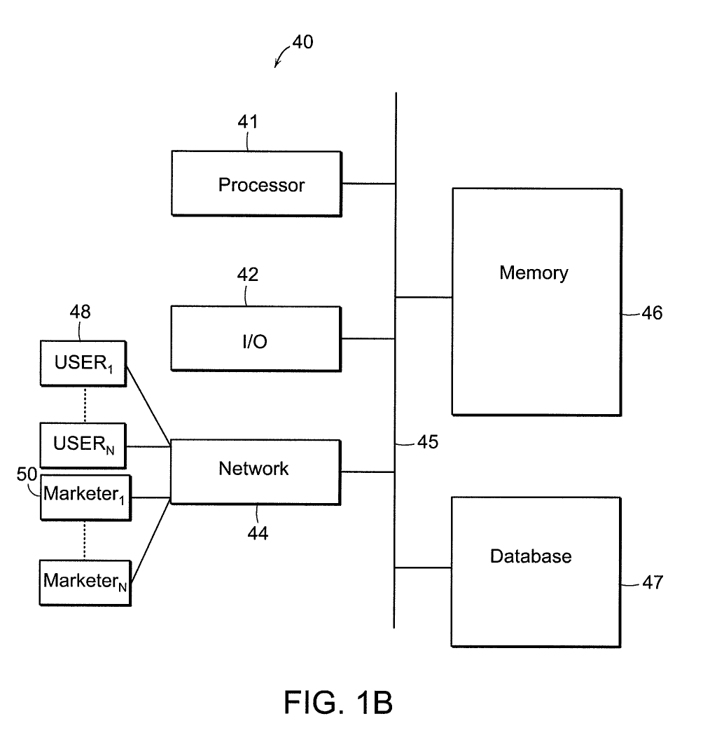

FIG. 1A illustrates a preferred process 10 for implementing preferred embodiments of the invention. This process utilizes a public access network in which a first group of users, such as those seeking to pay their bills or debts using electronic transfers from their bank accounts, who elect 12 to utilize the service. A second group of users also elects 14 to participate by registering to participate for the purpose of marketing particular goods or services. The second group, or marketers, gains access 16 to a system database to identify potential users interested in those products and services. The marketer can then identify and make appointments 18 with a particular subgroup of users and design 20 a conversation to initiate the interaction. After conversations are deployed 22 users respond in connection with one or more bill-paying transactions 24. After notification and tracking 26, the response is downloaded 28 and recorded 30; followed by marketing 32 and measurement of response 34.

Shown in FIG. 1B is a system used to perform online analytical processing (OLAP) in accordance with a preferred embodiment of the invention. A computer system or server 40 has a processor 41, input and output devices 42, a network connection 44, memory 46 and database systems connected by a bus 45. The network enables connection to a multiplicity of users 48 and one or more marketers 50.

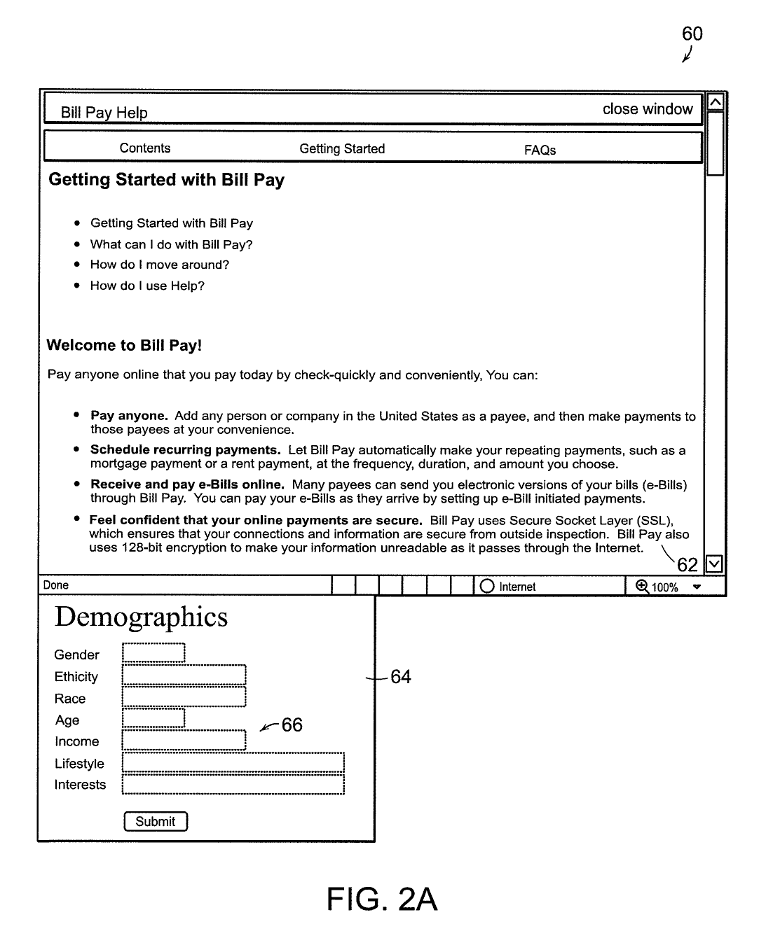

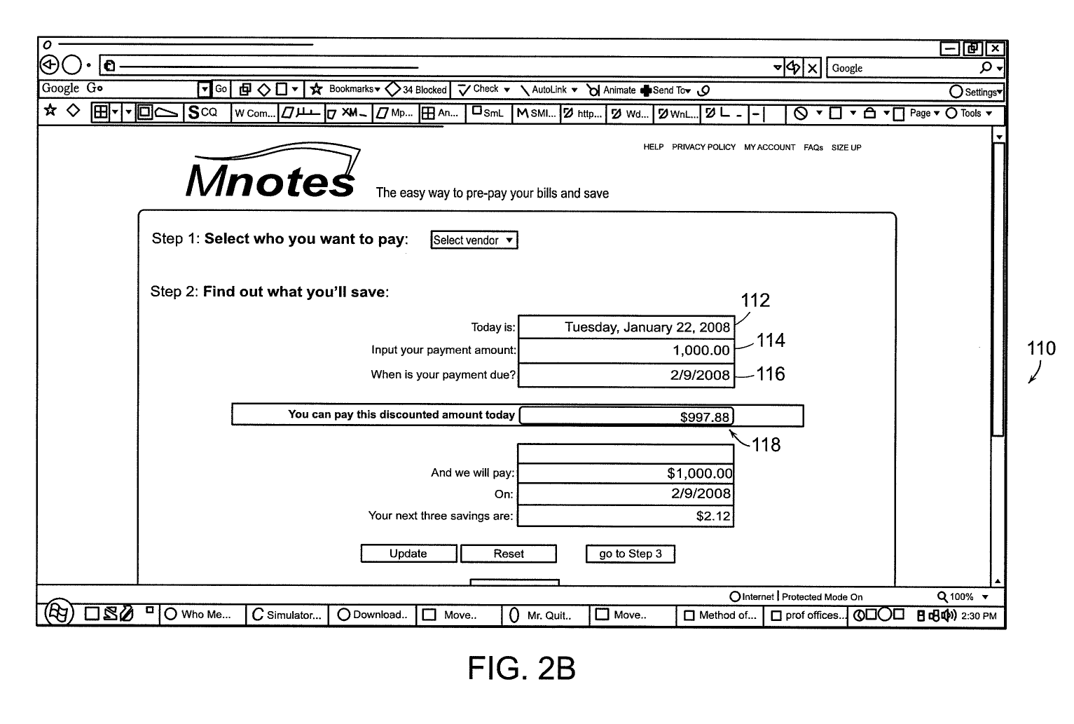

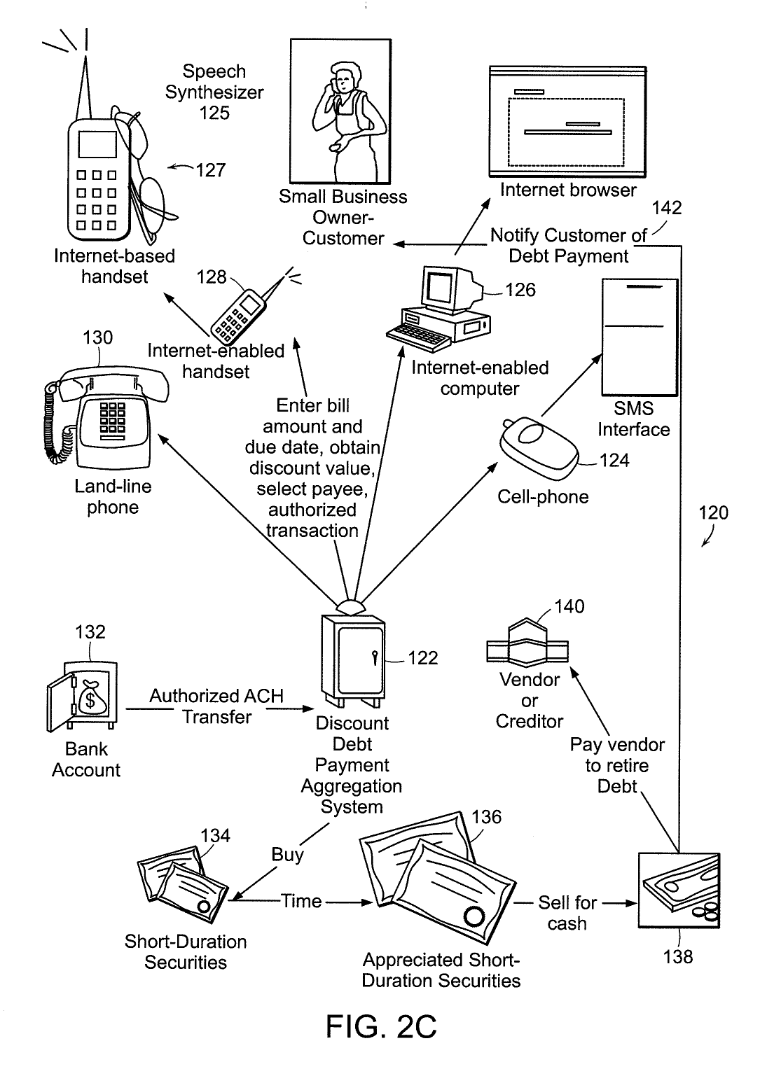

The database 47 can be an OLAP cube, for example, in which large quantities of user data or stored and used as described in greater detail herein. The database 47 can be queried using a search engine or routines based on search parameters selected by the marketer. An interface, such as, an application program interface (API) can be configured to enable searching of the database 47 based on selected search parameters. A further program including executable instructions can be stored in memory 46 or in memory associated with the database 47, can be used to generate reports for display, to perform specific queries or analyze data. The first group of users elects to participate by accessing a screen 60 with instructions 62 as shown in FIG. 2A. The user submits a preset required list of demographic data 66 entered on a form 64.

In a preferred embodiment a customer accesses a debt-discount service via a handset, computer, or telephone. The user enters the amount of their debt 114, such as a credit card bill, and its due date 16 using the graphical user interface 110 (GUI) as shown in FIG. 2B. The system returns a value which the customer can choose to accept or not. With acceptance, the customer completes the payee information, unless it is already stored, and the accepted value amount 18 is transferred from the customer's account to the system, which invests those funds in low-risk, short-duration financial investments, for example, and pays the amount due on the due date from the cash flows resulting from those investments. The system earns a spread on the difference between the discount rate offered and the return on invested funds.

Shown in FIG. 2C is a schematic diagram of a networked communication system 120 for debt payment conducted in combination with marketing communication in accordance with a preferred embodiment of the invention.

The system 120 can include a central processor or server 22 that communicates with users via cellular telephone 124, a computer 126 connected to a public access network, an internet enabled handset 128, or a standard telephone system (POTS) 130. The server 122 also accesses the user's bank account 132, a system for acquiring securities 134 which are stored 136 until transfer 138 for satisfaction of the debt held by vendor or creditor 140. Notice 142 can then be delivered to the user. The system can include a speech synthesizer 125 operated by a control 127 that can incorporate a program for detecting typographical errors in recording instructions and responses to queries by the user.

The present invention involves no annual fees nor does it provide credit and in fact, one purpose of the present invention is to eliminate late fees by incentivizing early payment.

In contrast to other early payment methods, the present invention provides a discount which can vary linearly with the time value of money, not with the value of purchases or other restrictions. Nor does the present invention involve extraction of money from the vendor to return to the debtor or credit card holder and does not accrue the discount but rather, renders it upon the first transaction.

Note that a preferred embodiment of the invention does not function after the due date of the debt. Note additionally that the present invention does not involve paying a debt with another debt. Alternatively, the present invention can be used to make a debt payment after the due date at an increased value, for example. The payments can be made, for example, using this system on specified dates to avoid penalties for late payment.

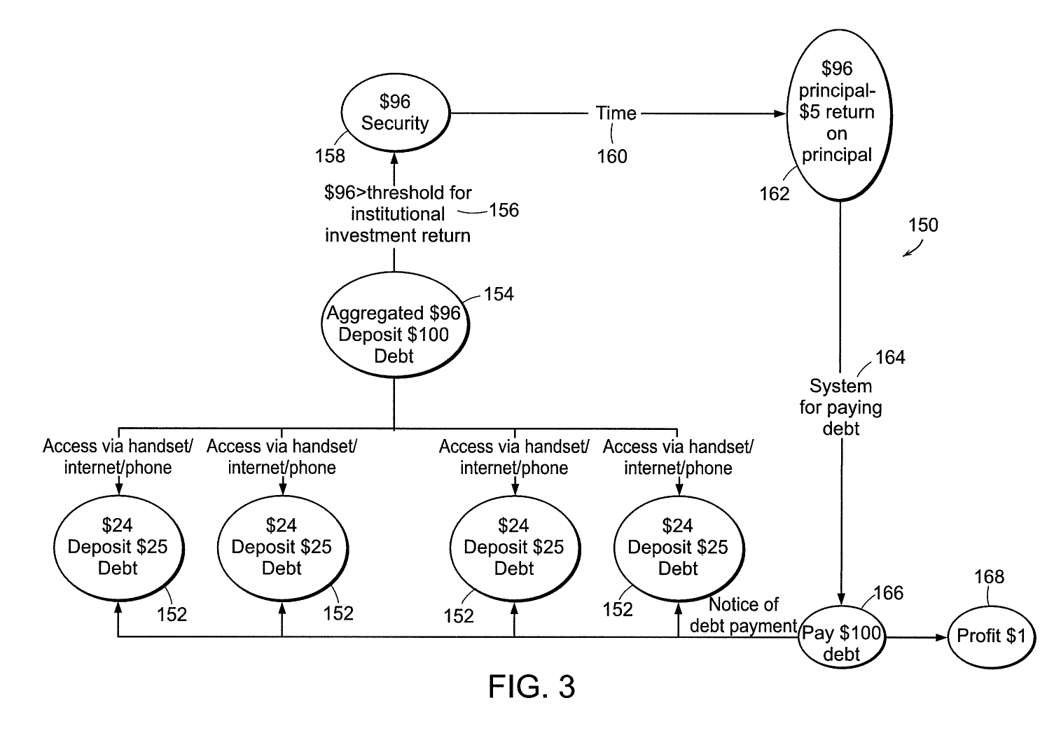

The system shown in FIG. 3 is a process sequence 150 that can be executed using a software program in which separate payments 52 that need to be made are aggregated 154, compared 156 to a threshold amount needed to make the secured transaction at 158 to acquire an instrument that increases in value over time period 160. The principal with the increased value 162 is then processed by system 164 to pay the debt 166. Any residual value 68 more than the actual debt obligation can be returned to user.

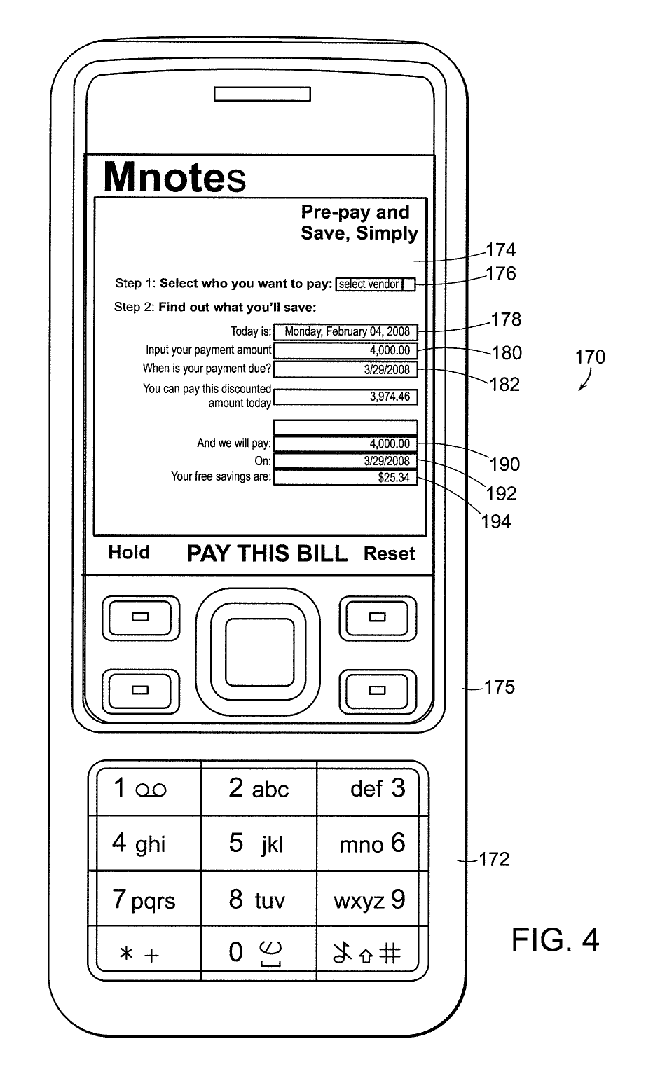

FIG. 4 illustrates an embodiment in which a wireless telephone 170 having an electronic display 174 is used to display a screen in which a vendor can be selected 176 to make the transaction. A keypad 172 is used to enter data onto data entry windows including the present date 178, the payment amount 180, the due date 182, the confirmation of payment 190 to be made on the selected date 192 and a line indicating the amount saved 194. A control panel 175 is used to activate the transaction.

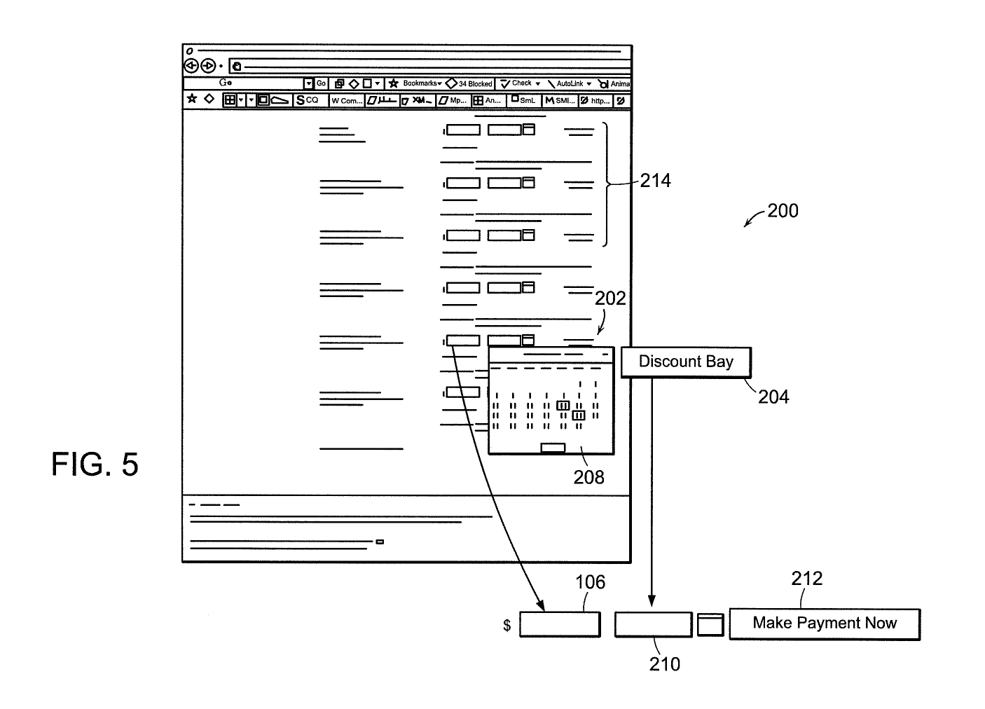

Illustrated in FIG. 5 is a screen 200 used by a bank or other vender for payment of debts that is accessed by the user to insert the required data fields for this operation. The debt payment field 202 is selected from a plurality of fields 214 including the amount of the debt 206, the present date and due date can be selected using a pull down calendar option 108, and the current payment 204 shown in field 210. A virtual button or control panel 212 can be used to execute the transfer.

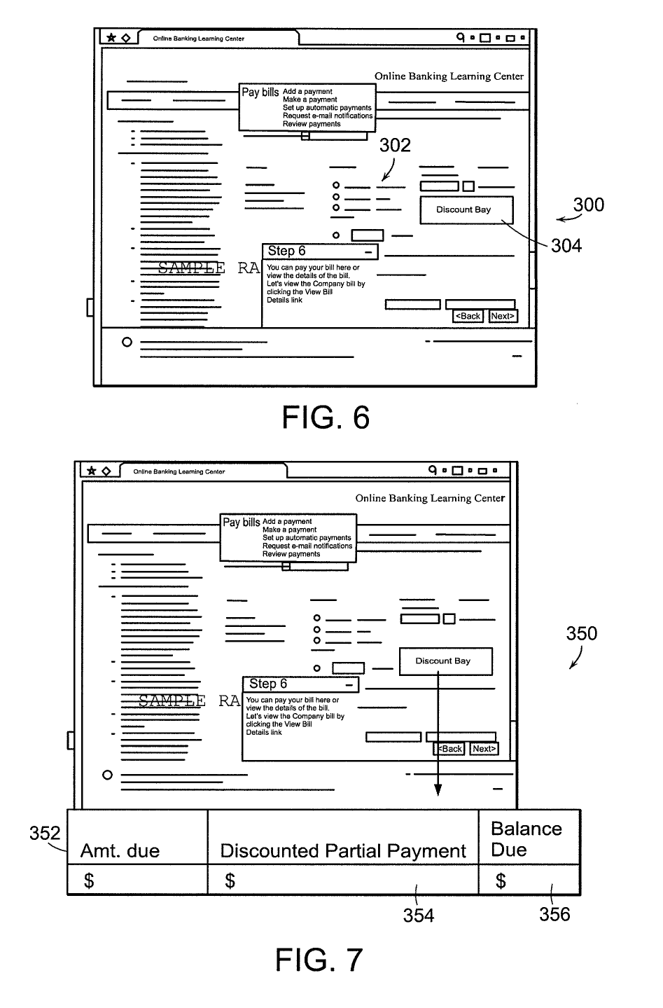

Shown in FIG. 6 illustrates a screen 300 of a bank or other vender having data entry fields 302 and control elements 304 to electronically execute discount payments as set forth herein. These payments can include those obligations to the bank or vendor or to other parties, companies, institution or individuals.

Shown in FIG. 7 is another preferred embodiment in which the user can enter the amount due 352, select a partial payment amount 354 to make a first payment, with a third field 356 used to confirm the amount still due.

Based on the periodic communication that occurs, typically on a monthly basis, in connection with many financial transactions, such as the electronic payment of debts, the present invention enables the marketer to start with a list of good quality leads and compensates users of the system to answer a few additional qualifying questions. For example, starting with the knowledge that they all purchased more than $50 in office supplies in the last 3 months at a competitors' office supply store, the marketer, with the single sales objective to sell a particular vendor's printer ink, might first ask 100 people “Do you own that vendor's printer?” From this answer the answer tree begins branching as illustrated below:

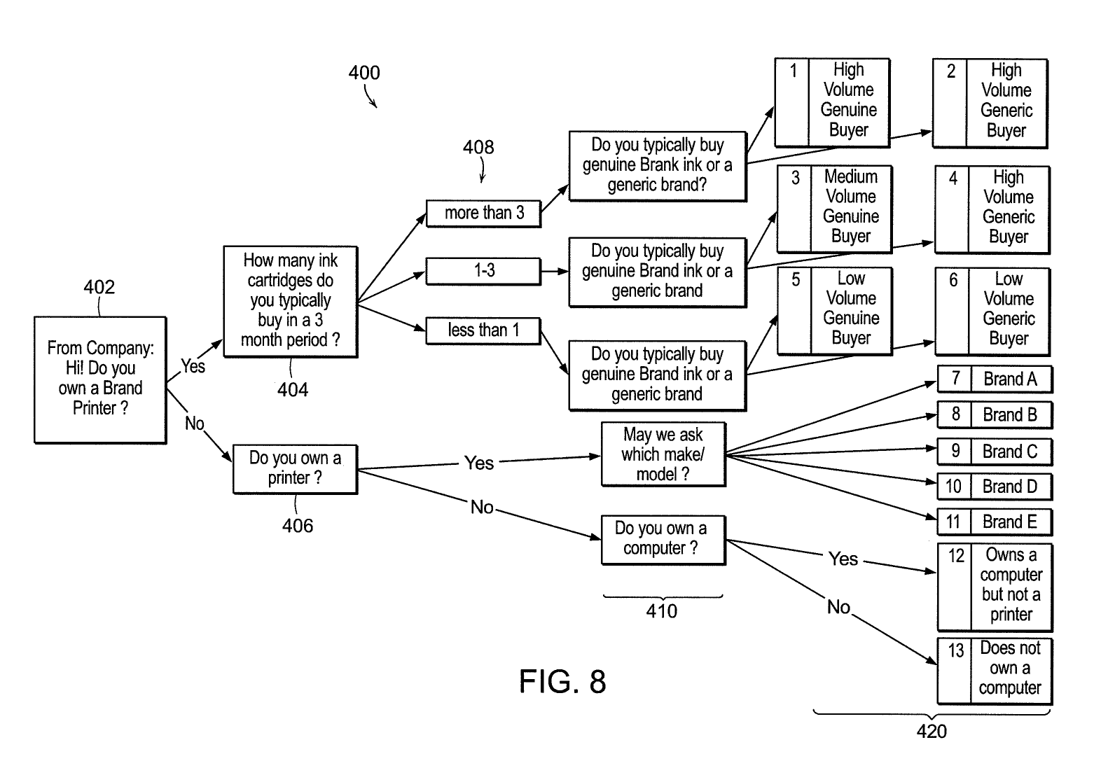

A communication sequence 400 having queries and responses in accordance with a preferred embodiment of the invention is illustrated in connection with FIG. 8, which demonstrates the creation of 13 distinctly different segments 420 requiring differentiated follow-up. In this particular example, the marketer seeks information regarding an office supply product, such as, printer ink. The first query 402 initiates the process, with responses resulting in a second queries 404, 406. Second response 408 then triggers third queries 410, producing the 13 different segmented responses 420. For example, it wouldn't make much sense to offer both segment 2 and segment 13 the same coupon for $5 off the genuine ink brand since in the case of segment 2, this high-volume user currently doesn't even buy the genuine ink brand and segment 13 doesn't even own a computer! Rather, each of these 13 segments, each a qualified lead for an ink seller—though not all for the genuine ink brand now requires an individualized second round of questioning. For example, it would be wise to understand the motivations driving the high volume generic users, segment 2, to buy off specification ink and explore if they have any problems with compatibility. Furthermore, there appears to be a computer purchase opportunity with segment 13, that's an entirely different line of questioning but possibly a big sale for the marketer. In aggregate, the system has taken 100 leads and through the marketer's investment, created 13 segments for possible further follow-up, or not, depending upon the attractiveness of the segment.

The important feature of this process is that this individualized follow-up is difficult in today's internet environment; including paid search where 97 of the 100 typically leave the site leaving behind not much more information than where they came from and where they went after leaving the site. The present invention, however, due to the authenticity and 4-8 year stability of the online banking community, as in the preferred embodiment, is able to provide a vehicle through which this sustained and increasingly relevant communication can occur. The culmination of which may be a highly customized and relevant offer (e.g. a $30 coupon for 3 genuine ink cartridges, a $100 off a new computer, $10 off any alternative ink brand) deliverable via an permission-based email coupon.

On the bill-payer's side of the transaction, the system is sustainable because each response—or redemption, instantly and observably reduces the bill-payer's bill therein providing immediate positive feedback for the bill-payer's action. Moreover, the economics of the system enable the bill-payer to earn in excess of $60/hour in the process, making this a sustainable and profitable vocation for most bill-payers. Moreover, each successive brand communication coupon is more relevant than the last making the experience of the bill-payer, who is also a consumer, more meaningful and satisfying; it's good to feel like you are being listened to.

Thus, preferred embodiments of the present invention utilize selected elements in combination.
1. A marketer accessing a database of stable and qualified consumers making financial transactions online, based on either demographic information or financial transactions.
2. A networked communication system to enable communication.
3. A system of delivering said communication in the form of a saving coupon to the consumer carrying out financial transactions online.
4. A system of instantly and observably delivering financial rewards, for example, via redemption of said savings coupon, to the bill-payer in return for responding to the communication.
5. A system of tracking responses and respondents so as to segment respondents by their response.
6. A system of delivering a follow-on communication to select previous respondents which is more relevant than the previous communication because previous responses are contemplated in the new communication.
7. A system of delivering an offer to purchase either within or outside the financial transaction environment.
8. A system of measuring the financial performance of the interactive marketing system.

Bill-payer access to the system comprises the steps of learning about the system through bank marketing using a system where demographics and third party data are accessed to complete the bill-payer profile. Personally identifiable information gets removed when name and street address are replaced with a code to protect the privacy of the bill-payer. Financial transactions for the bill-payer are aggregated and analyzed and merchant attributes are gathered in a fast-paced interaction or game and used later to convert transaction data into utilities, and then into lifestyle choices.

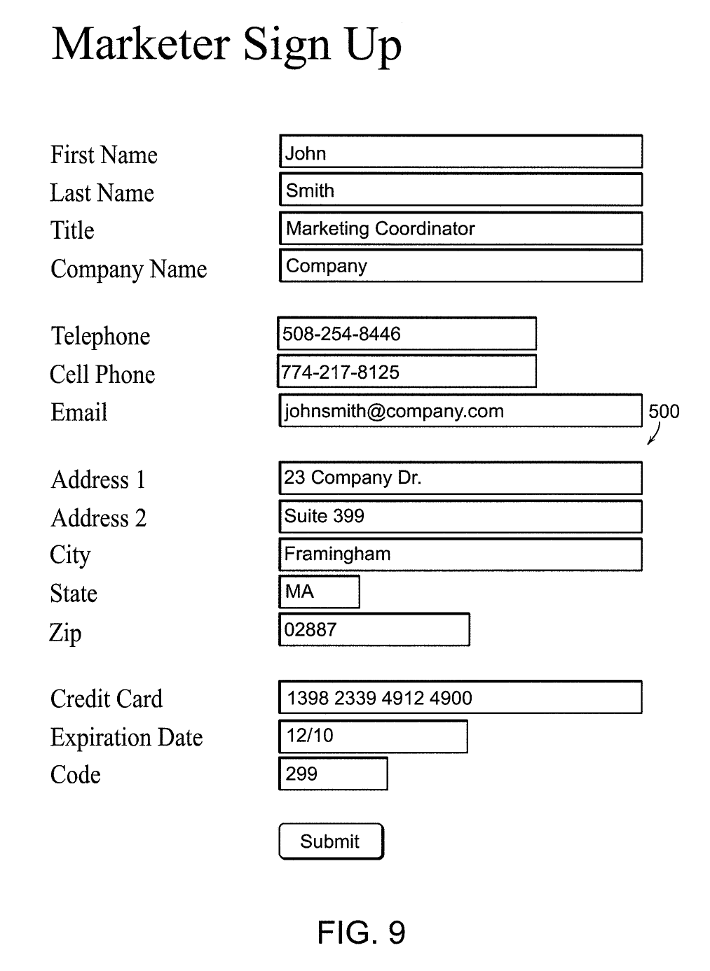

Marketers learn about the service through marketing and sales activities and tutorials and support are immediately available upon sign-up. The marketer accesses the system website and completes a form 500 shown in FIG. 9.

A powerful and flexible data query environment enables marketers to slice/dice and drill down to find targeted groups of bill-payers. For example, “find bill-payers who spent more than $50 on office supplies in the last 3 months AND NOT from a particular seller.” This is a compound query in which a plurality of query elements are used.

### Pre-Campaign

From data analysis, marketers select consumers with whom they'd like to book an appointment. Marketers then select the number of appointments as a subset of the search results, place/bill, expectations, and notification preferences. Purchase 100 appointments in March for $250. Average Seller purchases (previous 90 days) for group members, for example, can be $25/mo.

Marketers use a wizard 620 (FIG. 12) with template options, to design and test an interview. Marketers test by viewing the bill-pay screen the bill-payer will actually see.

### Campaign

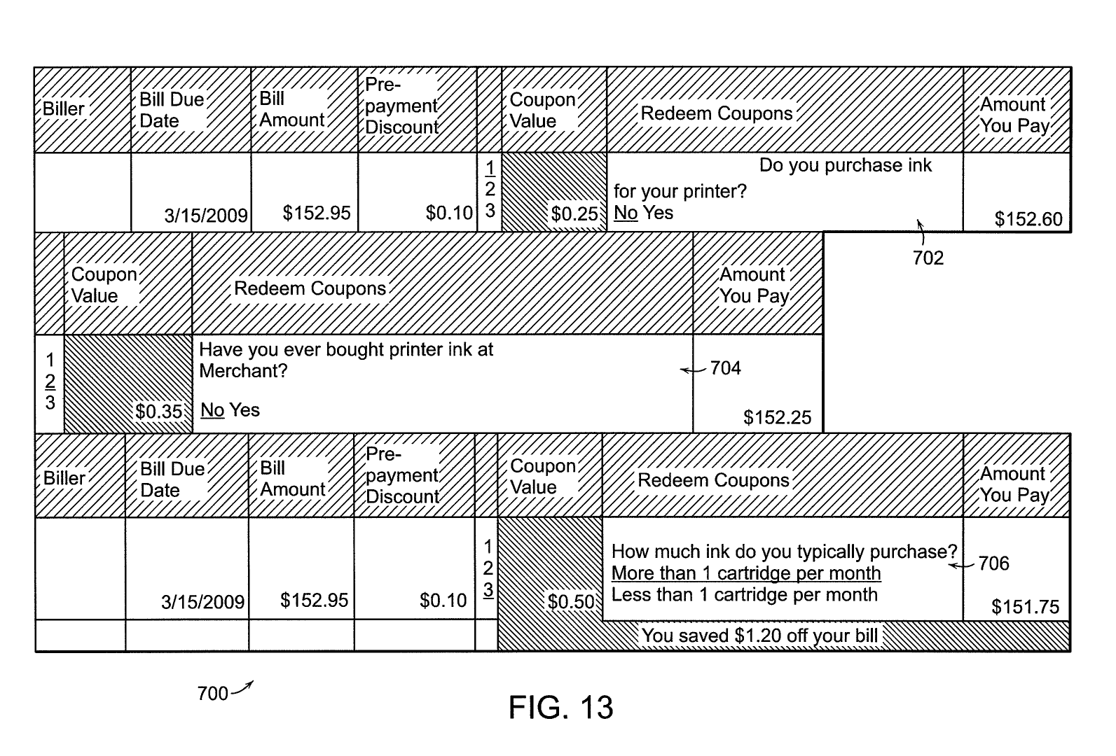

Bill payers redeem coupons by responding to questions 704, 706, shown in screen 700 of FIG. 13. Each response lowers the bill-payers bill thus compensating the user for responding to the communication, in this example $0.35 for the first answer and $0.50 for the second answer, thus augmenting the user discount for paying this debt before the due date. Responses 702 are tracked and segments are created.

### Post-Campaign

In an example, 22 Coupons delivered to 3 segments, with 3 coupon redemptions. Direct measurement of customer acquisition cost can, for example, be calculated as $250/3=$83. If lifetime value of a customer >$83, then further appointments continue.

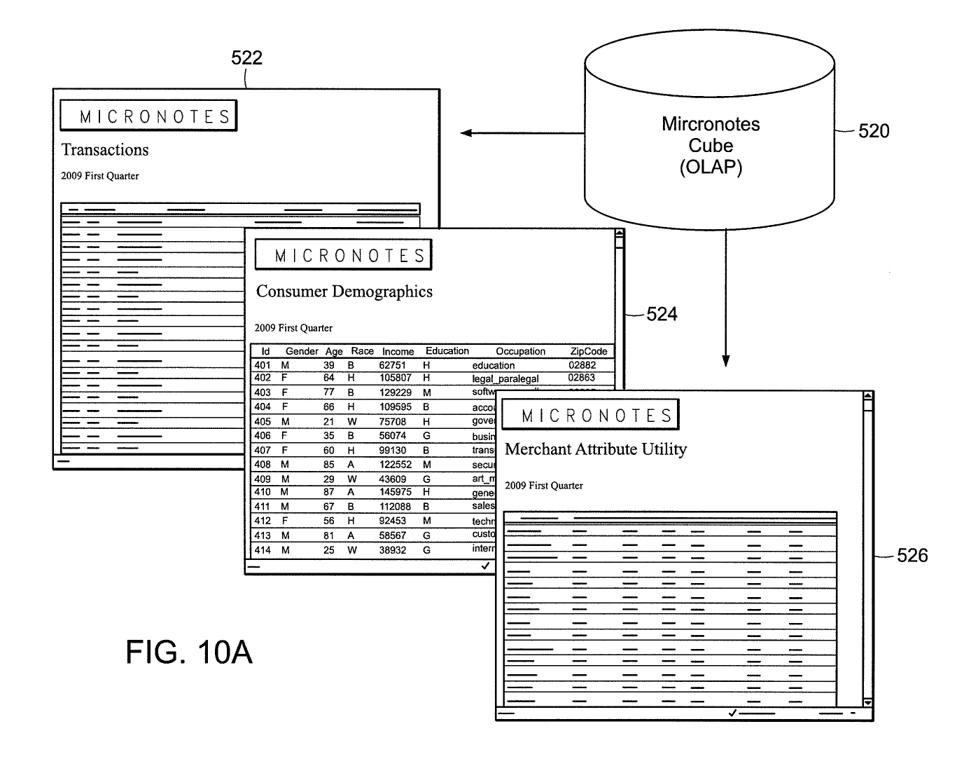

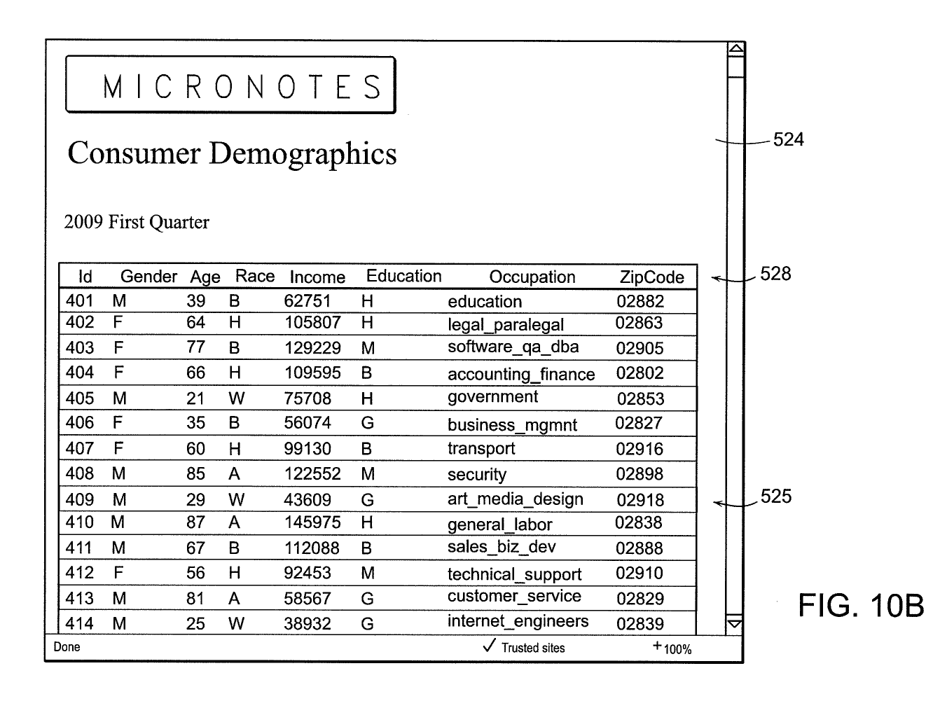

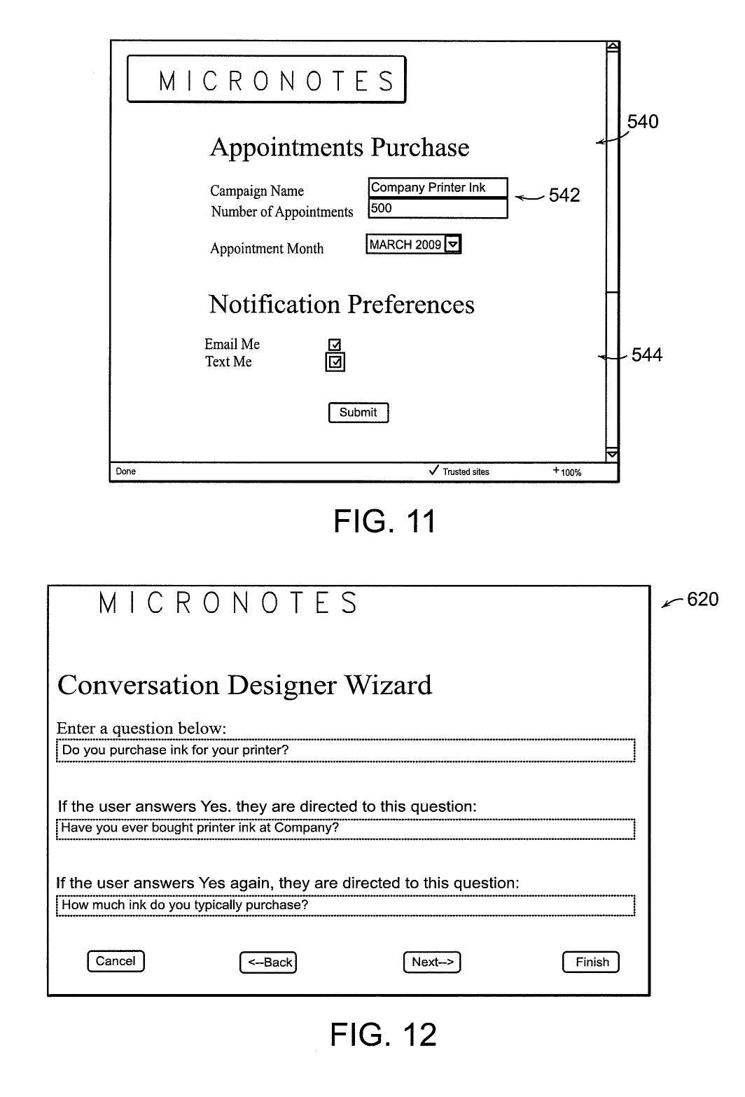

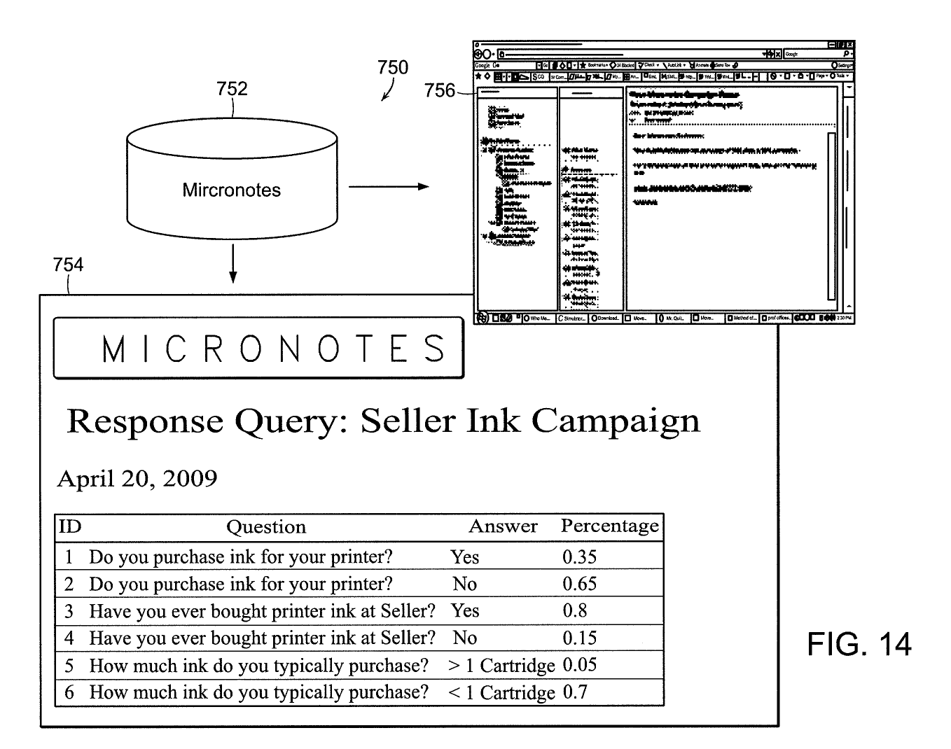

Statistically significant changes in group purchases are recorded in the transaction portion of the database 752 (shown in FIG. 14) in which the Seller records responses 754 and provides a status report 756, providing another measure of campaign effectiveness. As shown in FIG. 10A, the database or warehouse 520 has stored therein various datasets including transactions 522, user demographics 524 and merchant attribute utilities 526. The demographics data (FIG. 10B) identify the user by number and include attributes 528, such as, gender age, race, education, occupation and location by zip code. The data 525 contained in this dataset can be accessed to generate a list of users that can be identified by a marketer for appointment notification 540 (FIG. 11). The graphical user interface for notification 540 can include the name of the campaign 542 with the number of appointments, the month and year, or time period in which the sequence is executed and other details, such as, the manner of notification 544.

In a preferred embodiment of the invention, bill-payers are assigned lifestyle dimension utilities, and later segmented, in the manner described below:
For a system in which more than 10MM customers are included through online bank agreements wherein banks offer the service as an opt-in to their existing online bill pay service;
the system does not provide the name or address of any bill-payers;
the system has the permission by bill-payers to aggregate their transaction data, provided us with their online credentials, and answered these demographic questions on sign-up: Age, education, income, occupation, family size, dwelling zip code, stage in lifecycle, gender;
the system can utilize initial users who are compensated for characterizing the attributes of shoppers at the merchants where they shop; characterization is done in a game-like format;
reliable attributes are derived and assigned to merchants using the Bayesian Truth Serum (BTS) method (see below);
merchant shopper attribute data is collected until the rate of change in the merchant attribute set assigned using the BTS method approaches zero, or the cost of the nth consumer input is greater than the benefit of incrementally improved accuracy in the merchant shopper attributes assigned to a particular merchant; and
the database of bill payers is searchable by transaction, demographics, or attributes.

Attributes are assigned using the method that enables firms to engage in sustained interactive communications with qualified prospective and existing customers.

Certain firms have the ability to measure the effectiveness of their campaign because pre and post campaign purchase volume can be obtained.

Communication Method: (3) communications per online bill payment shown below comprising, for example:

One bill in the face amount of $152.95 from a utility company due on Dec. 22, 2008

(3) questions from the utilities company who paid more than 90 cents to ask these 3 question.

| | Bill Due | Amount | Amount | | Coupon | |
|---|---|---|---|---|---|---|
| Biller | Date | We Pay | You Pay | | Value | Redeem Coupons |
| Utility | Dec. 22, 2008 | $152.95 | $152.95 | 1 | $0.25 | Did you know that Utility |
| | | | | 2 | | offers free home energy |
| | | | | 3 | | analysis to save money? |
| | | | | | | No Yes |
| Utility | Dec. 22, 2008 | $152.95 | $152.70 | 1 | $0.30 | Do you use energy saving |
| | | | | 2 | | compact fluorescent light |
| | | | | 3 | | bulbs? No Yes |
| Utility | Dec. 22, 2008 | $152.95 | $152.40 | 1 | $0.35 | How drafty is your home? |
| | | | | 2 | | Very drafty Somewhat drafty |
| | | | | 3 | | Tight, no drafts. |
| Utility | Dec. 22, 2008 | $152.95 | $152.05 | | $0.90 | Total savings this bill. |

Pay
Sign out question: Would you like the utilities company to email to you tips on how to cut down on drafts?

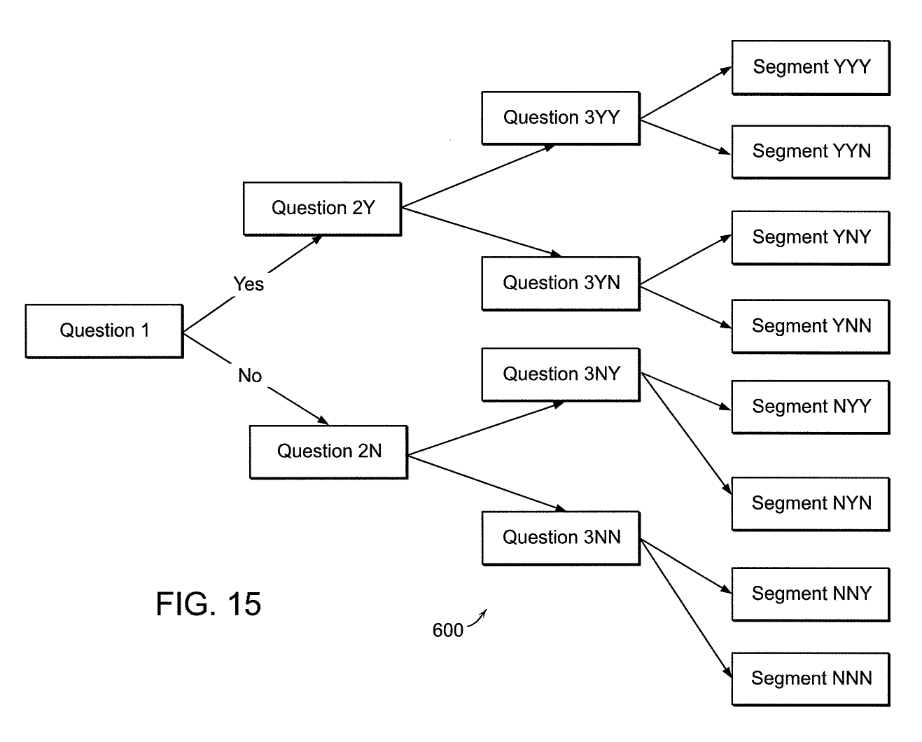

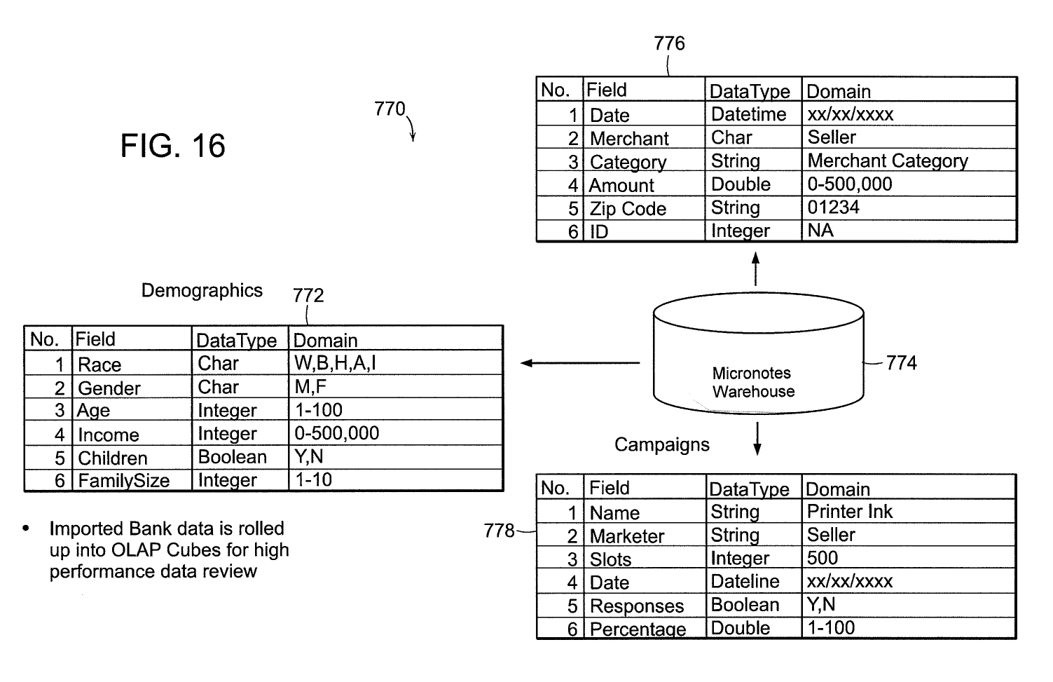

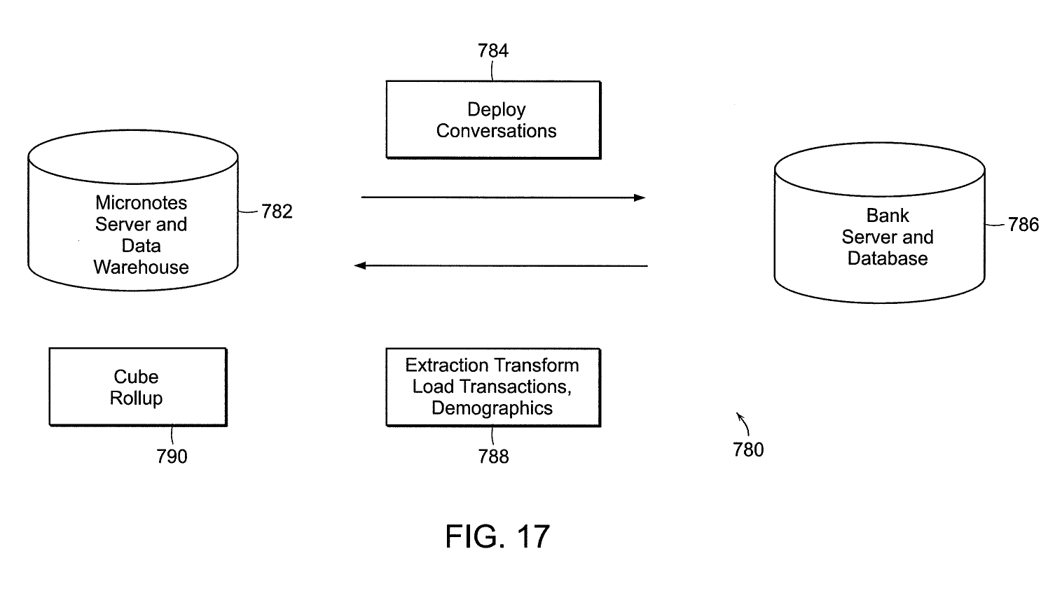

Procedure to create searchable database of participating bill-payers:
Online bill-payers opt-in to savings bill-pay at their local bank and answer 8 demographic questions and supply their user name and password for other financial institutions to aggregate data on the server. As shown in FIG. 16, the system 770 includes a database 774 accessible by merchants or sellers 776 in which demographics 772 and campaign data 778 are stored. The system includes a server 782 through which conversations with users are deployed 784, bank servers and databases 786, including user accounts, can be securely accessed for the purpose of conducting authorized financial transactions, the resulting record is then delivered 788 and stored in the server 782 database or warehouse with cube roll-up 790 providing a summary of the transactions and responses in combination.
The server downloads 90 days of transactions and presents merchant names and category specific questions (in the form of questions and answers 600, shown generally in FIG. 15) about each merchant's method of reaching their shoppers, and shopper motivation, lifestyle, culture and ethnicity as below—the process is presented in a game-like format where points are won for high information value answers.

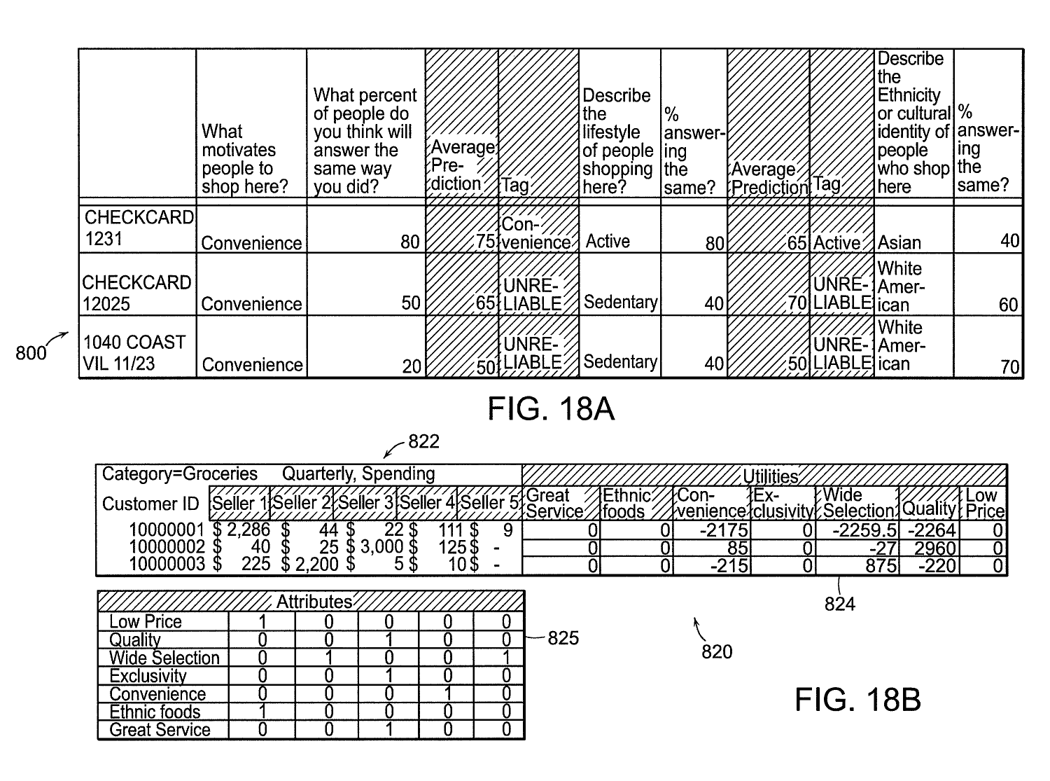

The attribute assignment process proceeds until the rate of change in the merchant attribute set assigned using the Bayesian Truth Serum (BTS) method approaches zero, or the cost of the nth consumer input is greater than the benefit of improved accuracy in the merchant shopper attributes assigned to a particular merchant. The BTS method shown, for example, in FIGS. 18A and 18B, can be summarized as follows, Subjective judgments are an essential but problematic information source for science and policy, problematic, because there are no public criteria for assessing judgmental truthfulness. See Prelec, D, “A Bayesian Truth Serum for Subjective Data,” Science, 15 Oct. 2004, Vol. 306, No. 5695, PP. 462-466, the entire contents of which is incorporated herein by reference. A scoring method is used for eliciting truthful subjective data in situations where objective truth is unknowable. The method assigns high scores, not to the most common answers, but to answers that are more common than collectively predicted, with predictions drawn from the same population. This adjustment in the scoring criterion removes all bias in favor of consensus: Truthful answers maximize expected score even for respondents who believe that their answer represents a minority view. In FIG. 18A, the BTS rules 800 have been applied. For example, since the respondent answered 80 to the Grocers Market question, and that answer was above 75, the average prediction of all people who shopped at the market, then this answer is taken as being a valid tag of “convenience” for the store; Therefore, the financial transaction that shows up from this store will be coded “convenience”. Conversely, the answer 50 to the competitors' question was below the average prediction and marked as “unreliable”, the competitor would not necessarily be given the tag “convenience.”

Once attributes are assigned to particular merchants, the next person who shops at that store will be assigned utilities according to the method 820 shown in FIG. 18B. In this case, 5 food retailers or sellers 822 are identified and user data indicate a combination of parameters 824, such as, convenience, selection and quality are summarized and then tabulated 825 as attributes.

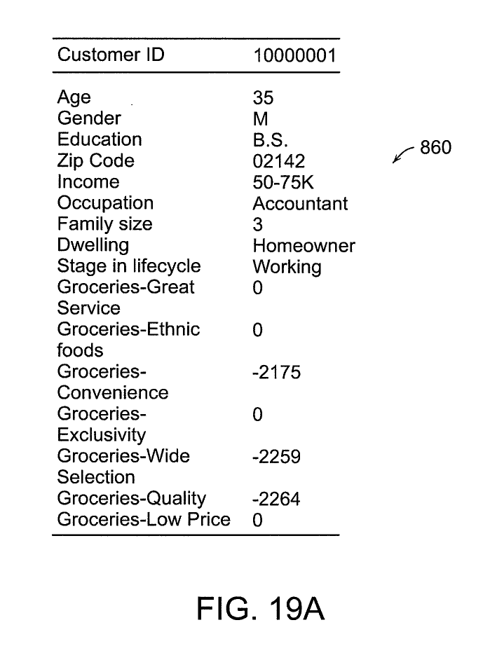

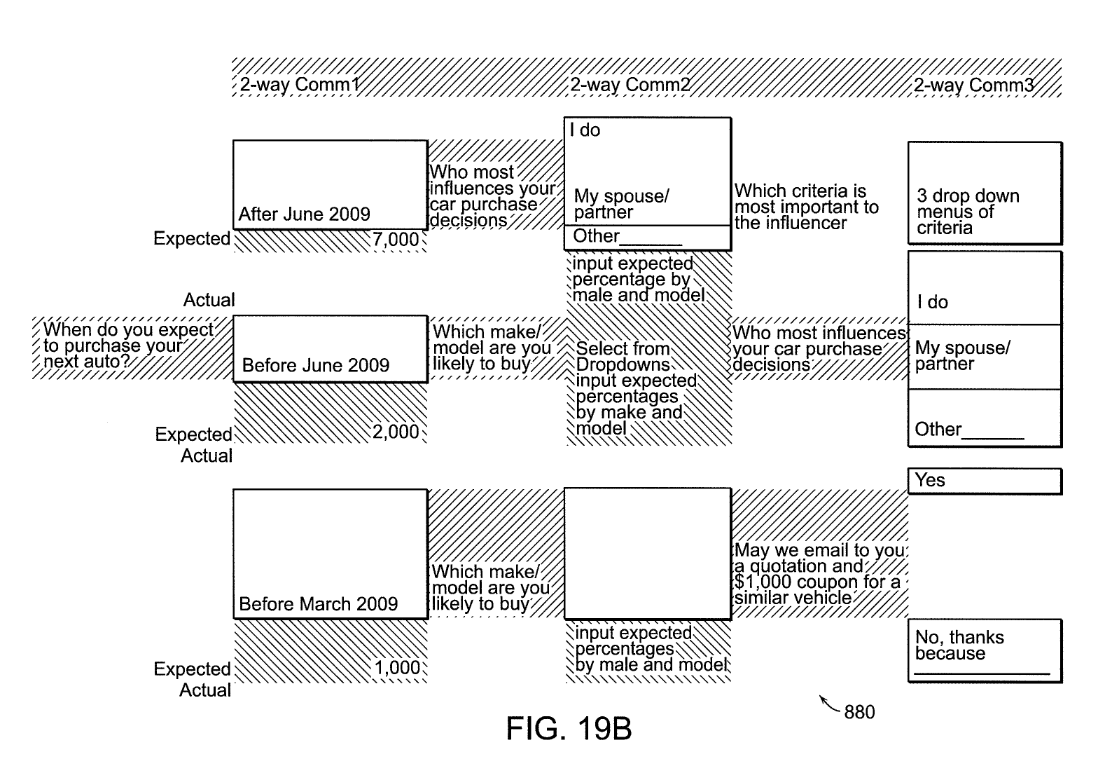

Once utilities are assigned for various categories (e.g. Grocery categories 860 shown in FIG. 19A) for each person, the database of users can now be searched by transaction, demographic, and/or category specific attribute utility.

For example: Simple Boolean logic can be employed, (e.g. for an office supply seller or vendor, find all users buying office products where the merchant does not equal). Moreover, cluster analysis can be performed using the utilities developed using the above method to find commonalities between users which may be opportunities for firms to expand their communications with specific customers who may exist in the same cluster but are not currently customers of the firm. For example,

Query 1: Find all users buying a particular vendor's office products.
Query 2: Find all users in the same cluster as those buying the particular vendor's products.

Build a communication campaign aimed at the adjacent clusters:

The marketer for that vendor then designs a series of communications aimed at understanding purchase intent (e.g. Are you planning to buy? Have you budgeted to buy? Where does the vendor stand competitively (strengths/weaknesses)? What would success look like? Who influences the buying decision? This is illustrated in the example below involving the purchase of a car (FIG. 19B):

Before, for example, a 3-month communication program 880 begins, the total of all customer purchases with the merchant (where data is available) is summed as a starting point. Once the questions are delivered through the online bill-pay system, the actual results of the questions are supplied to the marketer, and the next series of questions is designed based on the answers from the previous questioning. The goal is to build on the answers already supplied to move qualified prospects down the sales funnel and eliminate question repetition. Once the campaign is complete, results can be measured, in the case where the firm's name is shown in financial transaction data, in a variety of ways including:
1. Investment ($) in the campaign/incremental sales increase=cost/$ revenue
2. Incremental profit increase/Investment ($) in the campaign=$ return/$ invested

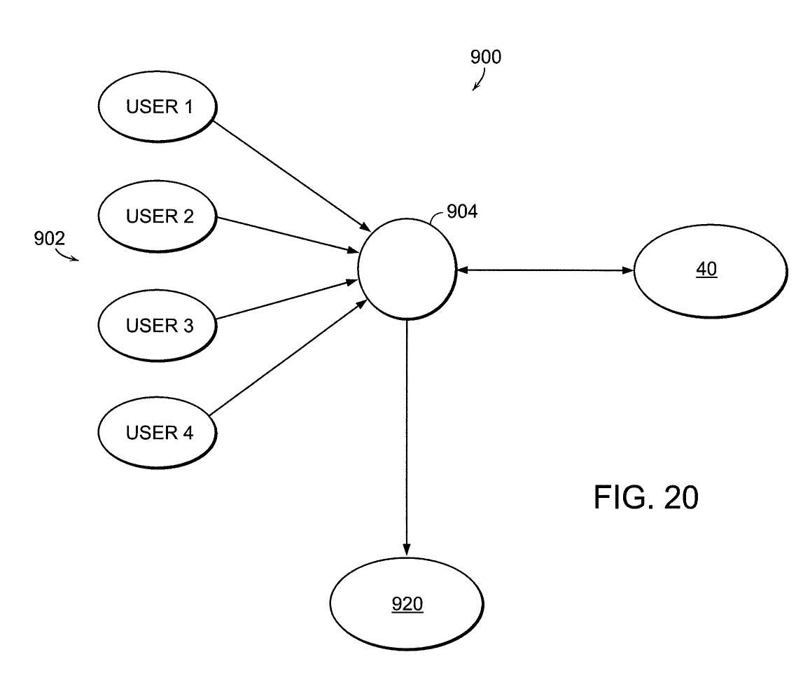

Illustrated in connection with FIG. 20 is a networked groups of participants or users 902 who elect to contribute funds on a periodic basis to a common account 904, the funds being used for purposes or rules agreed upon by the group of participants. In a preferred embodiment, the system can operate as a rotating savings and credit association (ROSCA) in which funds are electronically transferred (electronic funds transfer, ACH) from the bank accounts of individual members using system 40 described herein on a periodic basis into a common account. The aggregated funds are distributed according to the rules of the ROSCA, which can be to one or more members, or directed to some external person or entity 920.

While the present invention has been described herein in conjunction with a preferred embodiment, a person with ordinary skill in the art, after reading the foregoing specification, can effect changes, substitutions of equivalents and other types of alterations to the systems and methods that are set forth herein. Each embodiment described above can also have included or incorporated therewith such variations as disclosed in regard to any or all of the other embodiments. Thus, it is intended that protection granted by Letters Patent herein be limited in breath only by the appended claims and any equivalents thereof.

What is claimed is:

1. A computer-implemented method for conducting two-way communications between a marketer and a user, the method comprising:
populating a database with financial and demographic information from a group of users performing periodic financial transactions with a public access network;
querying the database by a marketer to determine a subset of the users;
constructing a series of two-way marketing communications with the subset of users;
communicating with the user in combination with a financial transaction being performed by each user with the public access network;
compensating the users for responding during the communicating step; and
recording responses and the responding users in a database.

2. The method of claim 1 further communicating with at least one of the subset of users based upon a prior response of the one user and compensating the one user for a second response.

3. The method of claim 1 further comprising delivering an offer to purchase a product either during or after the financial transaction.

4. The method of claim 1 further comprising measuring the financial performance of the interactive direct marketing system.

5. The method of claim 1 wherein a price of the communication to the marketer is obtained through an auction process.

6. The method of claim 1 wherein a user's lifestyle data are assigned to the user based on a user's purchase history.

7. The method of claim 6 wherein purchase histories are converted to lifestyle data and stored, for later assignment to other buyers of a product, by buyers having the lifestyle data.

8. The method of claim 1 further comprising performing a financial transaction including paying a debt.

9. The method of claim 8 further comprising:
acquiring a financial instrument that increases in value with time prior to the debt being due; and
using a transferable value from the financial instrument to pay the debt.

10. The method of claim 9 further comprising determining a discount for a debt payment using an amount of time between the acquiring of the financial instrument and when the debt is due.

11. The method of claim 9 further comprising determining a discount for the debt using increase in value of the financial instrument at a maturity date.

12. The method of claim 8 further comprising determining a discount for the debt using a discount amount made available by a creditor to a debtor.

13. The method of claim 9 wherein the step of acquiring a financial instrument comprises acquiring a financial asset.

14. The method of claim 8 further comprising using a typographical error detection system comprising:
a user interface;
a display for displaying text; and
a speech synthesizer including a loudspeaker, arranged to convert an input, dependent upon a text, to an audio output representative of a person reading the text; and a control that controls the display and for providing an input to the speech synthesizer, arranged to control the display of a text, to provide an input corresponding to the displayed text to the speech synthesizer, and to highlight a portion or portions of the displayed text, wherein the highlighting of a text portion is delayed with respect to the audio output corresponding to the text portion.

15. The method of claim 1 further comprising forming a group of users that elect to transfer financial proceeds in accordance with a group rule.

16. The method of claim 15 wherein the rule comprises distributing proceeds to a user periodically.

17. The method of claim 9 wherein the financial instrument increases in value and is issued by an entity to whom the debt is owed.

18. The method of claim 1 wherein a series of communications from a marketer are exchanged for a series of payments to one or more users.

19. The method of claim 1 further comprising using a system that can seek and obtain authorization from the user to debit, at the time of bill payment, from a bank account of the user.

20. A system for conducting financial transactions in combination with marketing communication comprising:
a processing system having a computer program to access a database having user demographic and financial data;
a public access communication network connected to the processing system; and
a user interface that can be connected to the processor with the communication network.

21. The system of claim 20 wherein transfer of funds further comprises acquiring a financial instrument that increases in value with time.

22. The system of claim 20 wherein the user connects to the network with a cellular telephone.

23. The system of claim 20 wherein the telephone has a display and a data entry device that enters data for a debt and to respond to a communication.

24. The system of claim 20 further comprising a bank server connected to the system accessing user bank accounts to perform financial transactions using the system.

25. The system of claim 20 further comprising:
a program having executable instructions for performing a communication sequence between a marketer and a plurality of users, the users providing responses to queries in sequence in combination with a plurality of periodic financial transactions.
